(19) United States
(12) Patent Application Publication
(10) Pub. No.: US 2021/0039321 A1
(43) Pub. Date: Feb. 11, 2021

(54) FABRICATING SYSTEM FOR FABRICATING A THREE-DIMENSIONAL OBJECT AND ITS CONTROL SYSTEM

(71) Applicant: Yasuaki YOROZU, Tokyo (JP)

(72) Inventor: Yasuaki YOROZU, Kanagawa (JP)

(73) Assignee: Ricoh Company, Ltd., Ohta-ku, Tokyo (JP)

(21) Appl. No.: 16/963,438

(22) PCT Filed: Mar. 25, 2019
(86) PCT No.: PCT/JP2019/012348

§ 371 Date: Jul. 20, 2020

(30) Foreign Application Priority Data
Mar. 30, 2018 (JP) 2018-066521

(51) Int. Cl. B29C 64/393

(52) U.S. Cl. CPC B29C 64/393; B33Y 50/02

(57) ABSTRACT

A control system for controlling a fabricator that fabricates a three-dimensional object according to fabrication data includes an estimation unit, a correction unit, a measurement unit, an estimated error calculation unit, and a modification unit. The estimation unit estimates a change of at least one of a shape and a characteristic caused in the three-dimensional object. The correction unit corrects the fabrication data according to an estimation of the change estimated by the estimation unit. The measurement unit measures at least one of the shape and the characteristic of the three-dimensional object fabricated by the fabricator. The estimated error calculation unit calculates a difference between a measurement result of the at least one of the shape and the characteristic measured by the measurement unit and the estimation of the change. The modification unit modifies the estimation according to the difference calculated by the estimated error calculation unit.

### TECHNICAL FIELD

The present invention relates to a control system to control a fabricator that fabricates a three-dimensional object, a fabricating system including the control system, and a recording medium storing a program for causing a computer to execute the control.

### BACKGROUND ART

A fabricating apparatus, which fabricates a three-dimensional object, forms one layer at a time using a molten material to fabricate the three-dimensional object. At this time, the molten material is given a shape in the molten state and is cooled and solidified. In the process of cooling, contraction is caused and the shape is deformed.

For the purpose of suppressing the deformation, a technology of decomposing the shape into basic small shapes, fabricating a plurality of samples having the decomposed basic small shapes, checking how the samples are deformed, estimating deformation due to the fabrication using the checked information, and correcting fabrication data has been proposed (for example, see PTL1).

### CITATION LIST

### Patent Literature

PTL 1: WO-2016-04281-A1

### SUMMARY OF INVENTION

### Technical Problem

However, in the above-described technology, the temperature change in the process of cooling and the stress applied are different between a target three-dimensional object and a decomposed sample. Accordingly, the contraction rate is different between the target three-dimensional object and the decomposed sample, thus causing a limitation in accuracy of the estimation of deformation.

The present invention is made in light of the above-described problem and a purpose of the present invention is to provide a system and a program that allow estimation of deformation and correction with high accuracy.

### Solution to Problem

According to embodiments of the present invention, there is provided a control system for controlling a fabricator that fabricates a three-dimensional object according to fabrication data. The control system includes an estimation unit, a measurement unit, an estimated error calculation unit, and a modification unit. The estimation unit estimates a change of at least one of a shape and a characteristic caused in the three-dimensional object. The measurement unit measures at least one of the shape and the characteristic of the three-dimensional object fabricated by the fabricator. The estimated error calculation unit calculates a difference between a measurement result of the at least one of the shape and the characteristic measured by the measurement unit and an estimation of the change estimated by the estimation unit. The modification unit modifies the estimation according to the difference calculated by the estimated error calculation unit.

According to embodiments of the present invention, there is provided a fabricating system that includes the control system and the fabricator to fabricate the three-dimensional object.
According to embodiments of the present invention, there is provided a recording medium storing program code for causing a computer to execute a control method of controlling a fabricator that fabricates a three-dimensional object according to fabrication data. The control method includes estimating a change of at least one of a shape and a characteristic caused in the three-dimensional object; correcting the fabrication data according to an estimation of the change by the estimating; measuring, with a measurement unit, at least one of the shape and the characteristic of the three-dimensional object fabricated by the fabricator; calculating a difference between a measurement result of the at least one of the shape and the characteristic measured by the measuring and the estimation of the change; and modifying the estimation according to the difference calculated by the calculating.

### Advantageous Effects of Invention

According to the present invention, estimation of deformation and correction can be performed with high accuracy.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a diagram illustrating a configuration example of a fabricating system.

FIG. 2 is a diagram illustrating an example of a hardware configuration of an information processing apparatus.

FIG. 3 is a diagram illustrating an example of a hardware configuration of a fabricating apparatus.

FIG. 4 is a block diagram illustrating an example of functional configurations of the information processing apparatus and the fabricating apparatus.

FIG. 5 is a flowchart illustrating an example of processing executed by the information processing apparatus.

FIG. 6 is a diagram illustrating a data flow in the fabricating system.

FIGS. 7A to 7F (FIG. 7) are diagrams describing estimation of a change in a shape or the like to correction based on a fabricating process model.

FIGS. 8A to 8D (FIG. 8) are diagrams illustrating processing of comparing an estimation result of the shape or the like based on the fabricating process model with a measurement result and of updating the estimation result.

### DESCRIPTION OF EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

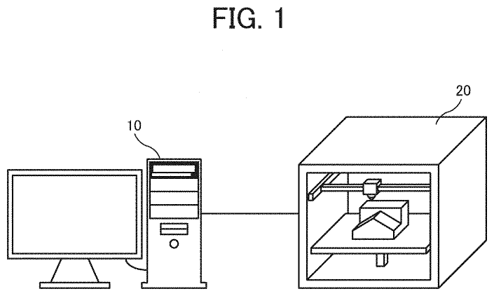

FIG. 1 is a diagram illustrating a configuration example of a fabricating system that fabricates a three-dimensional object. The fabricating system illustrated in FIG. 1 includes an information processing apparatus 10 and a fabricating apparatus 20 that fabricates a three-dimensional object. The information processing apparatus 10 and the fabricating apparatus 20 are connected by wires using a cable or the like, or wirelessly connected using a wireless LAN or the like. Note that the information processing apparatus 10 and the fabricating apparatus 20 may be connected via a network.

In this example, the fabricating system includes two apparatuses, but the fabricating system may include one apparatus or three or more apparatuses. For example, the fabricating system may include functions of the information processing apparatus 10 and a fabricator that forms a three-dimensional object, both of which are housed in one housing, or may include three or more apparatuses, including two or more apparatuses to which the functions of the information processing apparatus 10 are distributed and an apparatus including a fabricator.

The information processing apparatus 10 transmits fabrication data as control information for controlling the fabricating apparatus 20 to the fabricator, which is in this example the fabricating apparatus 20. The fabricating apparatus 20 receives the fabrication data from the information processing apparatus 10 and fabricates a three-dimensional object according to the fabrication data.

The information processing apparatus 10 creates the fabrication data according to three-dimensional shape information (3D data) indicating a three-dimensional shape of the three-dimensional object such as computer aided design (CAD) data created using a program of CAD or the like, and transmits the fabrication data to the fabricating apparatus 20. At this time, the information processing apparatus 10 creates, from the 3D data, a plurality of pieces of cross-sectional information (slice data) indicating a cross-sectional shape obtained by cutting (slicing) the three-dimensional object at predetermined intervals. Then, the information processing apparatus 10 determines a plurality of routes for supplying a fabrication material according to the plurality of slice data and creates the fabrication data according to route data of the plurality of determined routes.

The fabrication data includes parameters required for fabrication such as a temperature at which a resin is melted and a moving speed of a fabricating head as a discharger, in addition to information as to from where to where the resin as the fabrication material (material) is supplied. Note that the discharger is not limited to the fabricating head as long as the discharger can supply the material.

The fabricating apparatus 20 moves the fabricating head according to the fabrication data received from the information processing apparatus 10, supplies the material through the fabricating head, and forms one layer at a time to be stacked, thereby fabricating a desired three-dimensional object. The fabrication is performed by linearly discharging the material through the fabricating head while moving the fabricating head. Note that the width of a line changes depending on a diameter of a discharge nozzle of the fabricating head, a discharge amount, and the moving speed of the fabricating head.

The fabricating apparatus 20 moves the fabricating head in two-dimensional directions (an x-axis direction and a y-axis direction) and moves a stage on which the three-dimensional object is placed in a vertical direction (a z-axis direction), thereby stacking the layers of the material to fabricate the three-dimensional object. Specifically, the fabricating apparatus 20 lowers the stage by one step after moving the fabricating head in two-dimensional directions and fabricating one layer, thereby fabricating the next layer on the fabricated layer. Note that the movement is not limited to the above example, and the fabricating apparatus 20 may perform movement in the x-axis direction and y-axis direction by movement of the stage and movement in the z-axis direction by movement of the fabricating head.

In the fabrication using a resin as the material, the shape is imparted in a molten state by heat, and cooled and solidified. The fabricated three-dimensional object is contracted in the process of cooling. In this contraction, in a case where the resin is a crystalline resin, the crystallinity changes and a contraction rate differs depending on, in particular, what temperature change has occurred or how much stress is applied. Further, the applied stress and expressed strength change with the change in the crystallinity and orientation characteristics. Therefore, when the temperature changes or the stress changes, the three-dimensional object is deformed and the strength changes. Since such changes in the temperature and the stress are determined as a result of mutual influence in the entire three-dimensional object, the estimation needs to be made in consideration of such changes. In reality, estimation of the deformation with high accuracy is difficult. Hereinafter, a method for improving the estimation accuracy and improving the fabrication accuracy by updating the estimation according to a measurement result as required will be described.

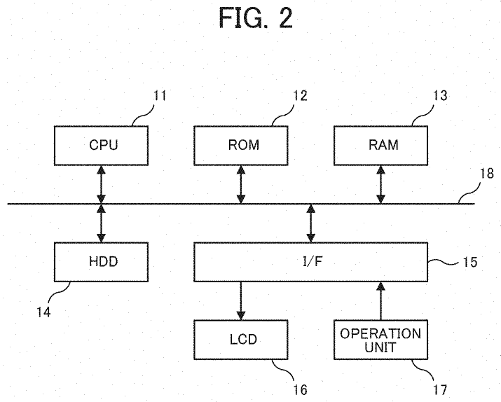

First, a hardware configuration of the information processing apparatus 10 will be described with reference to FIG. 2. The information processing apparatus 10 has a similar configuration to a general personal computer (PC). Therefore, the information processing apparatus 10 includes a central processing unit (CPU) 11, a read only memory (ROM) 12, a random access memory (RAM) 13, a hard disk drive (HDD) 14, an interface (I/F) 15, a liquid crystal disk (LCD) 16, and an operation unit 17. Note that the CPU 11, the ROM 12, the RAM 13, the HDD 14, and the I/F 15 are connected to one another via a bus 18. Further, the HDD 14 may be any storage device such as a solid state drive (SSD) as long as the storage device is a non-volatile storage device.

The CPU 11 is an arithmetic unit, and controls an overall operation of the information processing apparatus 10. The ROM 12 is a read-only non-volatile storage medium and stores a boot program and a program such as firmware for controlling hardware. The RAM 13 is a volatile storage medium capable of high-speed reading and writing of information and is used as a work area when the CPU 11 processes information. The HDD 14 is a non-volatile storage medium capable of reading and writing of information and stores an operating system (OS), various programs, various data, and the like.

The I/F 15 connects the bus 18 to various hardware, networks, and the like, and controls input/output and transmission/reception of information, and the like. The I/F 15 can include a network I/F for allowing the information processing apparatus 10 to communicate with other apparatuses via the network. As the network I/F, Ethernet (registered trademark), a universal serial bus (USB) interface, or the like can be used. The LCD 16 is a visual user interface for allowing a user to confirm the state of the information processing apparatus 10. The operation unit 17 is a user interface for allowing the user to input information to the information processing apparatus 10, such as a keyboard and a mouse.

The information processing apparatus 10 has functional units that implement various functions as the CPU 11 performs an arithmetic operation according to a program stored in the ROM 12 or a program read from the HDD 14 or a storage medium such as an optical disk (not illustrated) to the RAM 13. Note that all of the functional units may be implemented by execution of the program, a part of the functional units may be implemented by execution of the program the other part may be implemented by hardware such as a circuit, or all of the functional units may be implemented by hardware.

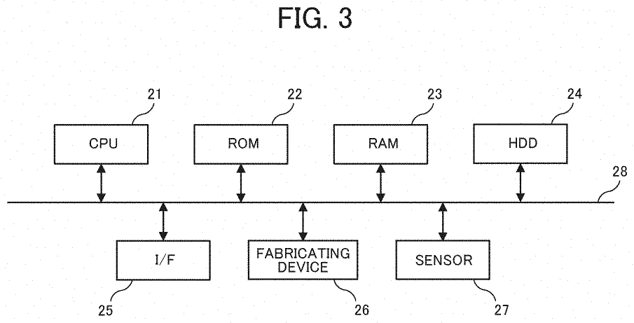

Next, a hardware configuration of the fabricating apparatus 20 will be described with reference to FIG. 3. The fabricating apparatus 20 includes a CPU 21, a ROM 22, a RAM 23, an HDD 24, and an I/F 25, and further includes a fabricating device 26, and a sensor 27. Note that the CPU 21, the ROM 22, the RAM 23, the HDD 24, the I/F 25, the fabricating device 26, and the sensor 27 are connected to one another via a bus 28. Further, the HDD 24 may be any storage device such as an SSD as long as the storage device is a non-volatile storage device.

The CPU 21 is an arithmetic unit, and controls an operation of the fabricating apparatus 20 and executes predetermined processing. The ROM 22 is a read-only non-volatile storage medium and stores a boot program and a program such as firmware for controlling hardware. The RAM 23 is a volatile storage medium capable of high-speed reading and writing of information and is used as a work area when the CPU 21 processes information. The HDD 24 is a non-volatile storage medium capable of reading and writing of information and stores an OS, an application program, setting information, and the like.

The I/F 25 connects the bus 28 to various hardware, networks, and the like, and controls input/output and transmission/reception of information, and the like. The I/F 25 can include a network I/F for allowing the fabricating apparatus 20 to communicate with other apparatuses via the network. As the network I/F, Ethernet (registered trademark), a USB interface, or the like can be used.

The fabricating device 26 is a device that supplies the fabrication material and fabricates a desired three-dimensional object, and includes a fabricating head that supplies the fabrication material, a stage on which the fabrication material is supplied and the three-dimensional object is fabricated, and the like. In a case of adopting a fused filament fabrication (FFF) method as a fabricating method, a heating mechanism that melts the fabrication material and the like are included. In a case of adopting a selective laser sintering (SLS) method as the fabricating method, a laser light source and the like are included.

The sensor 27 is a sensor that measures a shape of the three-dimensional object to be fabricated or a sensor that measures a characteristic of the three-dimensional object, for example, the temperature. The sensor that measures the shape of the three-dimensional object measures dimensions in a horizontal direction (x-axis direction or the y-axis direction) and a vertical direction (the z-axis direction) of the three-dimensional object. As the sensor that measures the shape of the three-dimensional object, an infrared sensor, a camera, a 3D scanner, or the like can be used. As the temperature sensor, a thermography or the like can be used.

The sensor 27 can measure the shape or the characteristic of the layer to be fabricated in conjunction with a fabricating operation by the fabricating head. Note that this measurement can be performed each time one layer is fabricated, and measurement timing and a range of the measurement can be any timing and range as long as the shape or the characteristic of the fabrication layer can be measured for each layer. The sensor 27 may be a sensor that measures the shape, may be a sensor that measures the characteristic, or may be both the sensors. The sensor that measures the characteristic is not limited to the sensor that measures the temperature and may be a sensor that measures a characteristic other than the temperature as long the characteristic influences the contraction of the material.

The fabricating apparatus 20 has functional units that implement various functions as the CPU 21 performs an arithmetic operation according to a program stored in the ROM 22 or a program read from the HDD 24 or a storage medium such as an SD card (not illustrated) to the RAM 23. Note that all of the functional units may be implemented by execution of the program, a part of the functional units may be implemented by execution of the program the other part may be implemented by hardware such as a circuit, or all of the functional units may be implemented by hardware.

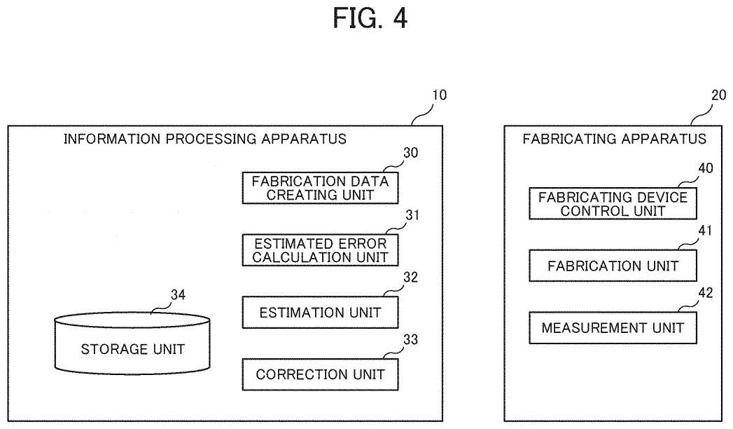

FIG. 4 is a block diagram illustrating an example of functional configurations of the information processing apparatus 10 and the fabricating apparatus 20. The information processing apparatus 10 includes a fabrication data creating unit 30, an estimated error calculation unit 31, an estimation unit 32, a correction unit 33, and a storage unit 34 as functional units. The fabricating apparatus 20 includes a fabricating device control unit 40, a fabrication unit 41, and a measurement unit 42 as functional units. The control system can include the functional units excluding the fabrication unit 41, and includes at least the estimated error calculation unit 31, the estimation unit 32, the correction unit 33, and the measurement unit 42.

The fabrication data creating unit 30 creates, from the 3D data, the plurality of slice data obtained by slicing the three-dimensional object at predetermined intervals, and creates the fabrication data from the plurality of slice data. The fabrication data is created as data indicating the fabrication layer for fabricating each layer and can be binary data indicating whether to fabricate in an xy plane coordinates of each layer. The fabrication data can include parameters required for fabrication, such as a melting temperature of the material and the moving speed of the fabricating head, in addition to the presence or absence of fabrication at each coordinate. These parameters can be set by the user and stored by the fabrication data creating unit 30. The parameters may be stored in the storage unit 34 that can be read and acquired by the fabrication data creating unit 30.

The estimated error calculation unit 31 compares a measurement result of the measurement unit 42 with change estimation of the shape or the characteristic of a fabricated object output by the estimation unit 32, according to the input from the fabrication data creating unit 30. Then, the estimated error calculation unit 31 calculates an estimated error indicating a difference between the measurement result and fabrication estimation. The measurement result is a result of measuring at least one of the shape and characteristic (hereinafter the shape or the like) of each layer being fabricated. For example, in a case where the measurement unit 42 measures first to n-th layers at time t and outputs measurement results, the estimated error calculation unit 31 compares the measurement results with the change estimation of the shapes or the characteristics of the first to n-th layers at the same time tin the fabrication estimation, and calculates the estimated error of the shape or the like. The estimated error is an amount indicating how much the measurement result is different from estimation of deformation and the like by fabrication.

The estimated error calculation unit 31 also calculates an error direction in addition to an error amount and outputs calculation results as an error vector including the error amount and the error direction. The estimated error calculation unit 31 can output the error vector to the estimation unit 32, but the error vector may be stored in the storage unit 34 and the estimation unit 32 may acquire the error vector from the storage unit 34.

The estimated error calculation unit 31 can acquire one or more measurement results and calculate one or more error amounts during a period from the start of fabricating one layer until the start of fabricating the next layer.

The estimation unit 32 estimates a change in the shape or the like caused in the three-dimensional object. That is, the estimation unit 32 estimates how the shape or the like changes according to a condition set on the basis of a fabricating process model in which a change in the temperature of the material discharged in a fabrication process, the contraction with the change in the temperature, occurrence of internal stress, deformation of a structure, and the like are modeled. Furthermore, the estimation unit 32 as a modification unit can modify the fabricating process model according to the error vector output by the estimated error calculation unit 31. Specifically, the estimated error calculation unit 31 calculates a difference between the result of measuring the shape or the like at the time t after fabricating the n-th layer and the shape at the time t estimated on the basis of the fabricating process model as the estimated error. Thereafter, the estimation unit 32 modifies the fabricating process model to explain the estimated error best on the basis of the estimated error. Since the shape or the like immediately after fabrication and those after cooling are different, the shape or the like in the process of cooling and the shape or the like when the displacement finally converges after cooling are estimated. The estimated results become a time series estimated value of the displacement and a convergence estimated value of the displacement.

Each time the estimation unit 32 acquires one or more estimated errors from the estimated error calculation unit 31, the estimation unit 32 can modify the fabricating process model and can modify the time series estimated value of the displacement and the convergence estimated value of the displacement. That is, each time the estimation unit 32 acquires the estimated error, the estimation unit 32 can calculate and update the time series estimated value of the displacement and the convergence estimated value of the displacement. As a result, the estimation unit 32 can update the estimation, reflecting the measurement result, and can improve the estimation accuracy.

The correction unit 33 corrects the fabrication data according to the shape or the like estimated by the estimation unit 32. That is, the correction unit 33 corrects the fabrication data so as to change the operation of the fabrication executed by the fabricating device control unit 40 on the basis of the time series estimated value of the displacement and the convergence estimated value of the displacement. Here, changing the operation of the fabrication refers to changing a parameter or an algorithm included in fabricating data. Examples the parameter or the algorithm include the shape of the three-dimensional object to be fabricated, a dimension or a height of each fabrication layer, a fabrication amount based on the fabrication data, the melting temperature of the fabrication material, a fabricating speed, and a stacking pitch.

The storage unit 34 stores the data measured by the measurement unit 42, the fabrication data created by the fabrication data creating unit 30, the time series estimated value of the displacement and the convergence estimated value of the displacement, and the like. The storage unit 34 is used by each functional unit, and various data are written and read.

The fabricating device control unit 40 controls the fabrication unit 41 according to the fabrication data corrected by the correction unit 33. The fabrication unit 41 executes processing of supplying the fabrication material onto the stage to fabricate the three-dimensional object under the control of the fabricating device control unit 40. The measurement unit 42 measures the shape of the three-dimensional object or the characteristic such as the temperature of the three-dimensional object fabricated by the fabrication unit 41.

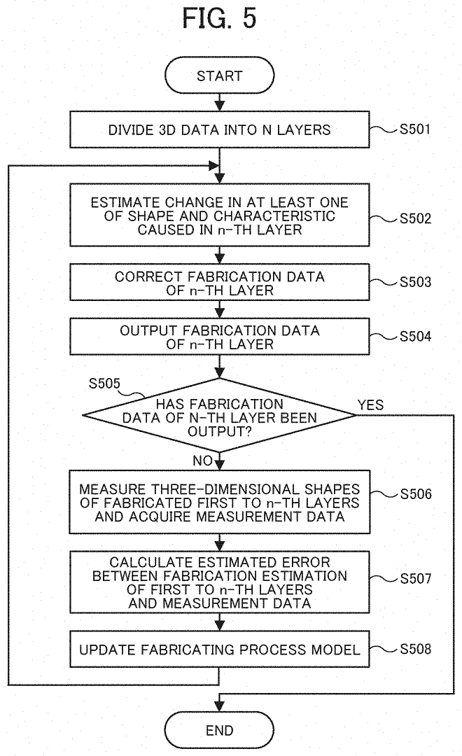

Since the fabricating apparatus 20 merely performs the fabrication according to the fabrication data and measures the shape or the like of the fabricated three-dimensional object, the processing executed by the information processing apparatus 10 will be described with reference to FIG. 5. The user specifies the 3D data, sets a fabrication condition, and instructs fabrication, thereby starting the processing from step 500. In step 501, the fabrication data creating unit 30 divides the 3D data into N layers to create the fabrication data of the first to N-th layers.

In step 502, the estimation unit 32 estimates the change in the shape or the like caused in the n-th layer (n is a natural number equal to or smaller than N) when the n-th layer is formed. The estimated shape or the like is output as the time series estimated value of the displacement or the convergence estimated value of the displacement.

In step 503, the correction unit 33 corrects the fabrication data of the n-th layer according to the time series estimated value of the displacement or the convergence estimated value of the displacement obtained by the estimation. Then, in step 504, the correction unit 33 outputs the fabrication data of the n-th layer to the fabricating apparatus 20. As a result, the fabrication unit 41 of the fabricating apparatus 20 fabricates the n-th layer, and the measurement unit 42 measures the shape or the like. The measurement result can be stored in the storage unit 34 as the measurement data.

In step 505, whether the fabrication data of the last N-th layer has been output is determined. In a case where the fabrication data has not been output, in step 506, the three-dimensional shapes of the first to n-th layers fabricated so far are measured and the measurement data is acquired. In step 507, an error between the change estimation of the shapes or the characteristics caused by the fabrication of the first to n-th layers and the acquired measurement data of the first to n-th layers is calculated.

In step 508, the estimation unit 32 updates the fabricating process model on the basis of the above error. Thereafter, the processing returns to step 502. The processing from step 502 to step 508 is repeated until the fabrication data of the N-th layer is output.

When the fabrication data of the N-th layer is output in step 505, the processing proceeds to step 509 and the processing by the information processing apparatus 10 is terminated.

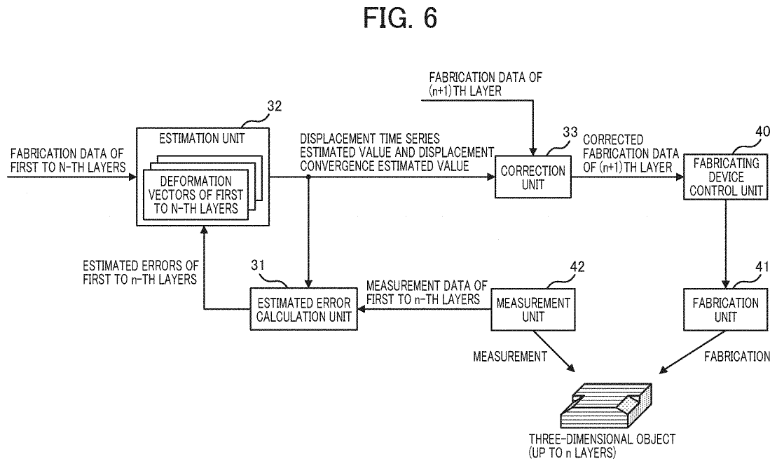

The flow of the data in the processing illustrated in FIG. 5 is as illustrated in FIG. 6. That is, the fabrication data creating unit 30 creates the fabrication data of the first to N-th layers from the 3D data. The fabrication data creating unit 30 sequentially outputs the fabrication data from the fabrication data of the first layer to the estimation unit 32. Regarding the fabrication data of the first layer, the first layer is not formed yet, the estimation unit 32 estimates the deformation or the like of the first layer under the initially set condition, and the correction unit 33 corrects the fabrication data of the first layer and outputs the fabrication data of the first layer to the fabricating device control unit 40.

When the n-th layer that is a subsequent layer of the first layer is fabricated by the fabrication unit 41, the measurement unit 42 measures the shape or the like and sends the measurement data of the first to n-th layers to the estimated error calculation unit 31. The estimated error calculation unit 31 compares the measurement data with the fabrication estimation of the first to n-th layers generated by the estimation unit 32, and calculates the estimated error of the shape or the like. For example, the estimated error of the shape is an estimated error caused by contraction amounts in the x-axis direction, the y-axis direction, and the z-axis direction of the first to n-th layers actually measured at the time t with respect to the first to n-th layers at the time t of the fabrication data being different from the estimation. For example, the estimated error of the characteristic is a difference between an expected temperature of the n-th layer at the time t of the fabrication data and the temperature of the n-th layer measured at the time t. The calculated estimated error is sent to the estimation unit 32. Each time the estimated error calculation unit 31 acquires the measurement result, the estimated error calculation unit 31 calculates the estimated error and outputs the estimated error to the estimation unit 32.

The estimation unit 32 acquires the estimated errors of the first to n-th layers, modifies the fabricating process model, estimates the change in the shape or the like, and calculates the time series estimated value of the displacement or the convergence estimated value of the displacement.

Each time the estimation unit 32 acquires the estimated error, the estimation unit 32 modifies the fabricating process model, guesses the deformation of the shape or the like, and can modify the time series estimated value of the displacement or the convergence estimated value of the displacement.

The correction unit 33 receives the calculated time series estimated value of the displacement or the calculated convergence estimated value of the displacement and an input of fabrication data of an (n+1)th layer that is the next fabrication data. The correction unit 33 corrects the fabrication data of the (n+1)th layer on the basis of the time series estimated value of the displacement or the convergence estimated value of the displacement. The correction unit 33 outputs the corrected fabrication data of the (n+1)th layer to the fabricating device control unit 40.

The fabricating device control unit 40 controls the fabrication unit 41 according to the fabrication data of the (n+1)th layer, and the fabrication unit 41 fabricates the (n+1)th layer on the n-th layer. Then, the measurement unit 42 measures the shape or the like of the (n+1)th layer and sends the measurement data of the (n+1)th layer to the estimated error calculation unit 31. The above processing is repeated until the N-th layer is fabricated.

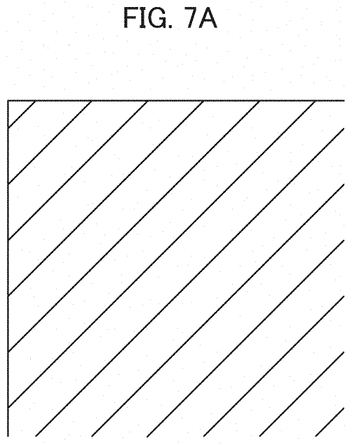

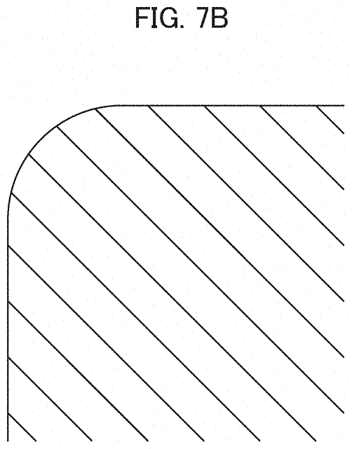

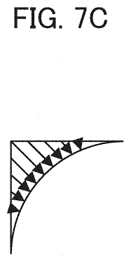

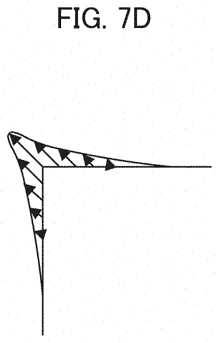

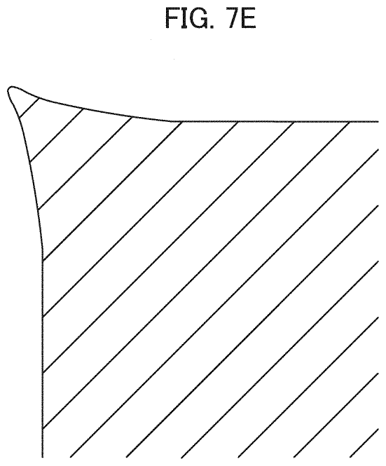

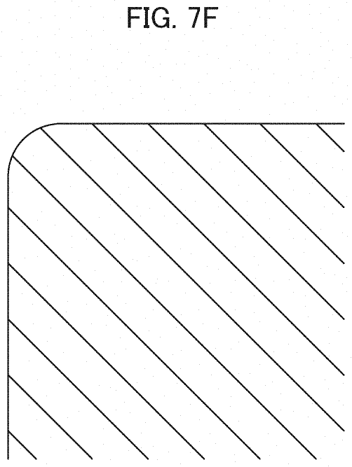

FIGS. 7A to 7F are diagrams for describing a method for correcting a shape and the like according to estimation of a change in the shape and the like using a fabricating process model. FIG. 7A is a diagram illustrating an example of the fabrication data illustrating the example, in this case, in a two-dimensional manner for easy understanding of the change in the shape of the three-dimensional object. In the fabrication data, the shape is rectangle, and corners are angular and angles are set to approximately 90°. FIG. 7A illustrates a part of the rectangular shape.

FIG. 7B is a diagram illustrating a result of setting the fabrication condition to fabricate the shape illustrated in FIG. 7A, and estimating the deformation with the fabricating process model. As a result of estimation based on the fabricating process model, the corner is rounded.

FIG. 7C is a diagram illustrating a change in the shape as to how the shape is deformed, comparing the fabrication data in FIG. 7A with the estimation result in FIG. 7B. The arrow indicates a deformation vector representing the direction and the magnitude of the deformation.

FIG. 7D is a diagram illustrating an example of a correction method. An example of the correction method includes a method for inverting the deformation vector, obtaining a correction vector in which the direction of deformation is rotated by 180° while maintaining the magnitude of the deformation, and applying the correction vector to the fabrication data illustrated in FIG. 7A. Since this method is an example, the correction method is not limited to this method.

FIG. 7E is a diagram exemplifying the fabrication data to which the correction vector has been applied and corrected. As a result of applying the correction vector, the corner that most greatly contracts is corrected to have a largely protruding shape.

FIG. 7F is a diagram estimating deformation as to be fabricated and estimating what the shape will be on the basis of the corrected fabrication data. In the shape illustrated in FIG. 7F, the size of the corner is reduced due to the effect of the correction although the roundness of the corner remains. The roundness of the corner is regarded as an error. Whether this error falls within an allowable range is determined, and when the error falls within the allowable range, data of the shape is set as corrected fabrication data and fabrication is performed.

On the other hand, in a case where the error falls outside the allowable range, the fabrication data illustrated in FIG. 7A is compared with the corrected shape estimation data illustrated in FIG. 7F, the deformation vector is obtained, the correction vector is obtained from the deformation vector, and the correction vector is further applied to the corrected fabrication data illustrated in FIG. 7E to correct the fabrication data. This processing is repeated until the error falls within the allowable range.

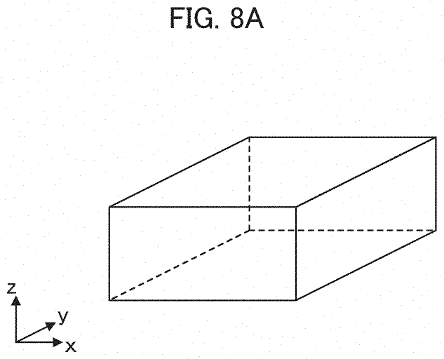

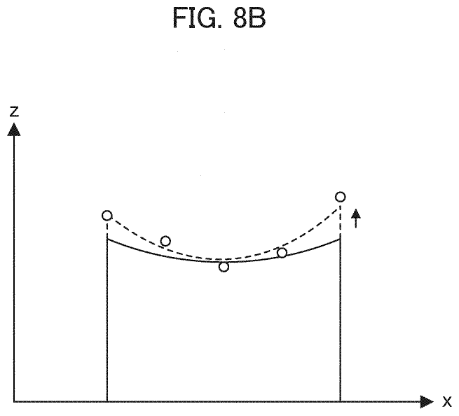

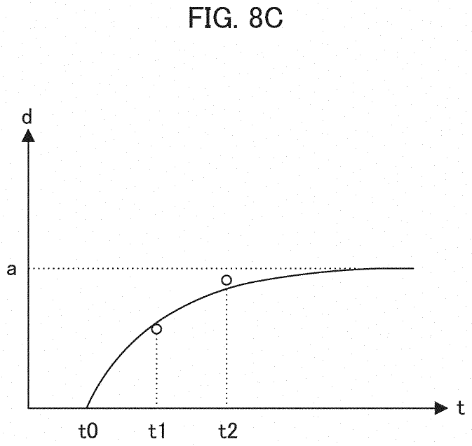

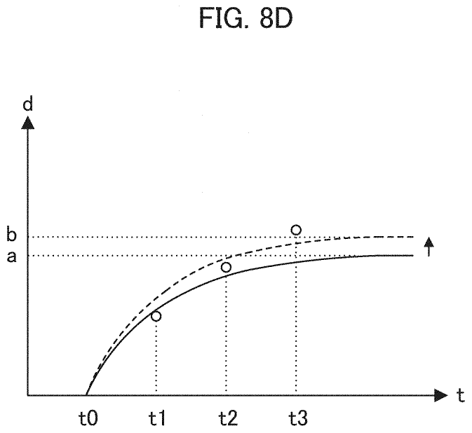

FIGS. 8A to 8D are diagrams for describing processing of comparing the estimation result of the shape or the like using the fabricating process model with the measurement result and updating the estimation result. Although the fabrication data can be corrected according to the estimation based on the fabricating process model as illustrated in FIGS. 7A to 7F, the time series estimated value of the displacement or the convergence estimated value of the displacement can be modified and updated reflecting the measurement result by the processing illustrated in FIGS. 8A to 8D.

FIG. 8A is a diagram illustrating an example of the fabrication data. In this example, the three-dimensional object to be fabricated is a rectangular parallelepiped. In the rectangular parallelepiped, the width direction is the x-axis direction, the depth direction is the y-axis direction, and the height direction is the z-axis direction.

FIG. 8B is a diagram illustrating a cross-sectional shape of the three-dimensional object cut by a plane parallel to an xz plane at a certain point of time during the fabrication. For simplification of description, assume that the shape of an upper layer of the cross section is expressed by a quadratic polynomial in the estimation based on the fabricating process model. Assume that the cross section becomes the shaded shape. Note that, since the parameters of the quadratic polynomial change depending on the actual fabrication condition, FIG. 8B illustrates expectation with a highest probability in the estimation of the shape.

Here, assume that a 3D scanner is used as the sensor 27 for measuring the shape during fabrication, the shape is scanned by the 3D scanner, and five points indicated by the circles in FIG. 8B are obtained. A plausible shape that explains the measurement result under the constraint that the shape is expressed by the quadratic polynomial assumed above is expected to be a shape illustrated by the dotted line spatially interpolating five points. Therefore, the parameter for estimation is updated so that the shape illustrated by the solid line becomes the shape illustrated by the dotted line.

FIG. 8C is a diagram illustrating how a certain point in FIG. 8A will be displaced during the fabrication or after the fabrication, at a certain point of time during the fabrication. In FIG. 8C, the horizontal axis represents time and the vertical axis represents a displacement amount of the point. A displacement amount d is expressed as the magnitude of the displacement vector.

For simplification of description, according to the fabricating process model, the displacement amount d is assumed to be expressed by the following expression 1. In the expression 1, α and β are parameters for estimation, and t0 is time at which measurement of fabrication of the appropriate point in FIG. 8A is started. Note that the parameters change depending on the actual fabrication condition.

d=α×(1−exp(−β(t−t0))) Expression 1

In FIG. 8C, the two points illustrated by the circles are points obtained by actual measurement at the time t1 and t2. The solid line is selected so as to satisfy the above expression 1 that is an estimation expression of the fabricating process model and to have the smallest errors from measured values at the time t0 and t1. Referring to the solid line, since the solid line approaches a constant displacement amount a with the lapse of time, the final displacement amount can be estimated to be the displacement amount a.

FIG. 8D is a diagram of when the time further proceeds from the state of FIG. 8C. In FIG. 8D, assume that the measurement result at time t3 is obtained. At this point, the estimated displacement amount selected so as to satisfy the above expression (1) as the estimation expression and to have the smallest errors from the measured values at the t0, t1, and t2 is updated as illustrated by the dotted line. Referring to the dotted line, since the dotted line approaches a constant displacement amount b with the lapse of time, the final displacement amount can be estimated to be the displacement amount b. Therefore, the estimation can be updated from the displacement amount a to the displacement amount b.

As described above, the estimation can be updated according to the measurement result. Since a dead angle occurs in the measurement, the shape of the three-dimensional object during the fabrication cannot be accurately measured by the 3D scanning. Therefore, as illustrated in FIG. 8B, deformation of a point that cannot be measured can be guessed by spatial interpolation reflecting the fabricating process model.

Further, since the deformation changes from moment to moment in time series due to the change in the fabrication condition, update of the estimation, reflecting the measurement result on the fabricating process model, is effective as illustrated in FIGS. 8C and 8D.

The present invention has been described as the control system, fabricating system, and the program according to the above-described embodiments, but the present invention is not limited to the above-described embodiments. Therefore, other embodiments, additions, alterations, deletions, and the like that can be changed within the range conceivable by a person skilled in the art and exhibit the functions and effects of the present invention in any aspect are included in the scope of the present invention. Therefore, in the present invention, a recording medium in which the method and the program of the method executed by the information processing apparatus are recorded, a server device that provides the program via a network, and the like can also be provided.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any conventional carrier medium (carrier means). The carrier medium can compromise a transient carrier medium such as an electrical, optical, microwave, acoustic or radio frequency signal carrying the computer code. An example of such a transient medium is a TCP/IP signal carrying computer code over an IP network, such as the Internet. The carrier medium can also comprise a storage medium for storing processor readable code such as a floppy disk, hard disk, CD ROM, magnetic tape device or solid state memory device.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

This patent application is based on and claims priority pursuant to 35 U.S.C. § 119(a) to Japanese Patent Application No. 2018-066521, filed on Mar. 30, 2018, in the Japan Patent Office, the entire disclosure of which is hereby incorporated by reference herein.

1. A fabrication system configured to fabricate a three-dimensional object according to fabrication data, the fabrication system comprising:
processing circuitry configured to
estimate a change of at least one of a shape and a characteristic caused in the three-dimensional object,
measure at least one of the shape and the characteristic of the three-dimensional object,
calculate a difference between a measurement result of the at least one of the shape and the characteristic and an estimation of the change, and
modify the estimation according to the difference calculated; and
a fabricator configured to fabricate the three-dimensional object.

2. The control system according to claim 1, the processing circuitry further configured to
correct the fabrication data according to an estimation of at least one of the shape and the characteristic.

3. The control system according to claim 2,
wherein the processing circuitry is further configured to modify estimation data obtained by estimating at least one of the shape and the characteristic at a specific time during fabrication or after an elapse of a predetermined time after fabrication, according to the difference calculated, and corrects the fabrication data of a layer to be stacked on an upper portion of a layer to be measured, according to the estimation data.

4. The control system according to claim 3,
wherein the processing circuitry is further configured to modify the estimation data each time at least one of the shape and the characteristic are measured during fabrication.

5. The control system according to claim 3, further comprising
a memory configured to store the estimation data modified by the processing circuitry.

6. The control system according to claim 3,
wherein the processing circuitry is further configured to determine whether the estimation data falls within an allowable range, and in a case where the estimation data does not fall within the allowable range, the processing circuitry is configured to correct the fabrication data.

7. (canceled)

8. A recording medium storing program code for causing a computer to execute a control method of controlling a fabricator that fabricates a three-dimensional object according to fabrication data, the control method comprising:
estimating a change of at least one of a shape and a characteristic caused in the three-dimensional object;
correcting the fabrication data according to an estimation of the change by the estimating;
measuring, at least one of the shape and the characteristic of the three-dimensional object fabricated by the fabricator; calculating a difference between a measurement result of the at least one of the shape and the characteristic measured by the measuring and the estimation of the change; and
modifying the estimation according to the difference calculated by the calculating.
